(19) United States
(12) Patent Application Publication
(10) Pub. No.: US 2007/0015850 A1
(43) Pub. Date: Jan. 18, 2007

(54) Preventative tire sealant composition and method

(76) Inventor: T. Daniel Ellsaesser, North Richland Hills, TX (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/369,705

(22) Filed: Mar. 7, 2006

Related U.S. Application Data
(60) Provisional application No. 60/699,035, filed on Jul. 14, 2005.

(51) Int. Cl. B29C 73/00

(52) U.S. Cl. 523/166

(57) ABSTRACT

A preventative sealant composition is shown which can be injected into inflatable tires. The composition has as principal components from about 5 to 95% by volume, based on the total volume of the composition, of an aqueous carrier medium, from about 95 to 5% by volume freezing point depressant, from about 3 to 10% by volume of fine ground rubber particles obtained from used tires; and from about 3 to 10% by volume of a corn meal gluten component.

### A. CROSS-REFERENCE TO RELATED APPLICATIONS

This application claims priority from a provisional application Ser. No. 60/699,035, filed Jul. 14, 2005.

### BACKGROUND OF THE INVENTION

B. Field of the Invention The present invention relates generally to the field of sealants suitable for use as puncture sealants in pneumatic tires and, more particularly, to a liquid, flowable tire puncture sealant composition used in a preventative fashion and containing commonly available ingredients.

C. Description of the Prior Art

The present day high cost of automobile tires justifies considerable effort in extending the useful life of such tires. A major cause for the reduction in tire life is under-inflation of the tire as a result of slow leaks. Another cause of shortened tire life is increased rolling resistance caused by out-of-balance tires. Furthermore, excess heat generated by the above two factors and other driving conditions can considerably reduce the life of a tire. A flat tire can be extremely dangerous if it occurs during operation on high speed highways. Direct dangers associated with changing a flat tire under highway conditions are well known. Equally well known are the indirect dangers associated with being stranded on the side of a highway, including collision with moving traffic. These various problems which result from leaking and punctured tires not only present an economic problem, but also can contribute significantly to the physical danger associated with automobile operation.

A number of different approaches have been tried over the years in addressing the problems associated with the loss of air from punctures in pneumatic tires. For example, in the patent art, U.S. Pat. No. 2,357,650, issued Sep. 5, 1944, discloses a tire sealant composition made by heating a mixture of 12 parts starch, 60 parts of glycerine or ethylene glycol, 55 parts water, 3 parts asbestos fiber, 8 parts salt and 11 parts of finely ground rubber.

U.S. Pat. No. 4,101,494, issued Jul. 18, 1978, teaches a tire sealant composition which is made from a mixture of asbestos fibers, fiberglass fibers, substantial amounts of polyvinyl alcohol and of water, together with several chemical additives.

U.S. Pat. No. 4,337,322, issued Jun. 29, 1982, discloses a sealant composition which is made using asbestos fiber, ethylene glycol monomer, polyethylene glycol, polyisoprene, process oil, detergent, sodium bicarbonate and water.

While, as shown above, the concept of injecting various compositions into a tire to seal punctures has also been known for some time, many of the prior art compositions proposed to date suffer from a variety of disadvantages. For example, one disadvantage of certain of the prior art tire puncture sealant compositions has been the tendency of fibrous materials (such as asbestos fibers) used in the conventional compositions to clump and ball up prior to entering the puncture. Inadequate sealing results when sealant fluid enters a puncture without the accompanying fibrous material. Some tires are manufactured with a liner and a built-in sealant, but they are generally more expensive to produce and are available in only smaller nominal sizes.

A need exists, therefore, for a tire puncture sealant that will satisfactorily seal punctures, and that will not react adversely with or damage other parts of the tire or wheel.

A need also exists for an automobile tire filling composition which provides continued sealing of slow leaks and thereby helps to maintain proper tire pressure and thereby to extend tire life.

A need exists for such a tire sealing composition which can be used in preventative fashion to assist in maintaining proper tire balance and thereby extends tire life.

A need exists for such a composition which will seal around an object which punctures a tire, the composition thereby preventing highway leaks.

A need further exists for such a composition which will actually seal the opening remaining when a puncturing object is removed from an automobile tire.

### SUMMARY OF THE INVENTION

The object of the present invention is to address the previously described needs with respect to a preventative sealant composition for pneumatic tires, such as automobile and truck tires.

This invention is a composition for injection into inflatable vehicle tires. The composition is a liquid which is flowable and can conveniently be injected into a deflated tire which provides long-term sealing of slow leaks, continuous wheel balancing of the tire, transfer of heat away from the tire body, and sealing of punctures in the tire before and after the puncturing object is removed. The composition includes an aqueous carrier medium, a freezing point depressant, a polymeric particulate component and an organic particulate component.

Additional objects, features and advantages will be apparent in the written description which follows.

### DETAILED DESCRIPTION OF THE INVENTION

The preferred sealant compositions of the invention utilize an aqueous medium, such as tap water as a carrier for the additional ingredients of the formulation. Water preferably comprises from about 5% to about 65%, preferably from about 40% to about 45%, and most preferably about 43.5% by volume of the tire puncture sealant.

The second preferred component of the formulations of the invention is a freezing point depressant. The freezing point depressant can be any conveniently available aqueous freezing point depressant. The tire puncture sealant of the invention will desirably have a viscosity ranging from about 1500 to about 20,000 centipoise and be operable over a temperature range extending from about −20 to about 212 degrees F. The freeze preventative component of the subject tire puncture sealant is preferably an alkyl polyol such as, for example, ethylene glycol, propylene glycol or glycerine, that will suppress the freezing point of the tire sealant composition to the lowest temperature level typically encountered during shipping, storage and normal service. The preferred freezing point depressant is propylene glycol which comprises from about 35% to about 95%, preferably about 40 to 45% by volume, and most preferably about 43.0% by volume of the tire puncture sealant.

The polymeric particulate component of the tire sealant compositions of the invention is preferably finely ground rubber. The ground rubber employed in the instant tire puncture sealant composition is recognized by those skilled in the art as post-consumer tire material which has been ground up, and processed for removal of unneeded fibrous and metal material, under controlled conditions. For example, ground rubbers having average particle sizes of 100 mesh (150 microns) to about 40 mesh (425 microns) and having a specific gravity of from about 1.10 to about 1.30 are acceptable for purposes of the present invention. The finely ground rubber component is preferably in the range from about 3 to 10% by volume of the total formulation, most preferably about 6.25% by volume.

The organic particulate component of the formulations of the invention is preferably a commercially available gluten. By the term “gluten” is meant a mixture of plant proteins found in cereal grains, chiefly corn and wheat, used as an adhesive and flour substitute. The preferred gluten component for purposes of the present invention is corn gluten meal which can be obtained commercially in grocery stores, or in bulk from grinding meals. The corn gluten meal is preferably present in an amount from about 3 to 10% by volume of the formulation, most preferably about 6.25% by volume. Generally speaking, the corn gluten meal substituent will be added until the desired viscosity of the liquid formulation is achieved.

In a particularly preferred embodiment of the invention, the gluten component of the formulations also contains wheat gluten, also commercially available from a number of sources. The wheat gluten component is present in the range from about 0.1 to 1.0% by volume, most preferably about 0.5% by volume and has been found to increase the “stickiness” of the product.

Another optional ingredient is an anti-rust additive such as zinc phosphate which can be present in the range from about 0.1 to 3.0%, most preferably about 1% by volume, when present.

In the practice of the invention it has been discovered that particularly useful embodiments result from the combination of the components within preferred ranges of concentration. A particularly preferred formulation for the subject composition are disclosed in the accompanying table, but it is emphasized that the disclosed formulation is merely exemplary of any number of similarly effective formulations that can be used within the scope of the invention.

TABLE I
(percentages by volume of total product formulation)

| | |
|---|---|
| Propylene Glycol | 43.0% |
| Water | 43.0% |
| Corn gluten meal | 6.25% |
| Finely ground rubber from used tires | 6.25% |
| Wheat gluten | 0.50% |
| Zinc Phosphate | 1.00% |
| Total ingredients | 100% |

The preferred tire sealant composition can be made by combining the ingredients in a convenient fashion. For example, the desired quantity of finely ground rubber (e.g. 40 mesh Tyler screen series) is placed in a one quart bottle. The corn meal and wheat gluten as well as any other solid components are also are added to the mixing bottle. The water and freezing point depressant are then added to the bottle and the bottle is shaken or mixed. It will be appreciated that the order of the steps carried out is generally preferred but not necessarily critical in order to achieve the desired end sealant composition.

The sealant composition of the invention can be utilized by either slow or high-speed vehicles. The application is based on tire size wherein a common 15 inch passenger vehicle tire requires only about 4 ounces of the sealant composition for continuous protection from flats and slow leaks caused by such things as nails, thorns or small debris.

In a preferred method of use, a rubber hose and a “Yorker Spout” available from Yorker Packaging of Greenville, S.C., are used to inject the liquid mixture into a deflated tire from which the valve core has been removed. After the desired quantity of sealant has been pumped into the tire, the container is removed. The valve core is then replaced in the tire and the tire is filled with the correct air pressure.

An invention has been provided with several advantages. Unlike many other sealants on the market, the sealant of the present invention utilizes as principal components ingredients which are inexpensive and readily available. The resulting formulations are not as gooey and thick as many of the prior art formulations, making them easier to dispense properly. The gluten and rubber particle components of the formulations go directly to a hole in the tire to plug the hole, much like the contents of an airplane are sucked out during cabin depressurization. In addition to its economical nature, the formulations of the invention can eliminate costly service calls and extend the useful like of a tire in which they are installed. The ingredients of the formulations of the invention are believed to be easier to handle and more environmentally safe than many of the ingredients used in making the sealants of the prior art, such as asbestos fibers. The resulting sealant compositions are also believed to be more durable and easier to handle that most of the available commercial tire sealant products presently on the market.

While the invention has been shown in only one of its forms, it is not thus limited but is susceptible to various changes and modifications without departing from the spirit thereof.

I claim:

1. A preventative sealant composition for injection into inflatable tires, the composition comprising:
from about 5 to 95% by volume, based on the total volume of the composition, of an aqueous carrier medium;
from about 95 to 5% by volume freezing point depressant;
from about 3 to 10% by volume of fine ground rubber particles obtained from used tires; and
from about 3 to 10% by volume of a corn meal gluten component.

2. The composition of claim 1, wherein the aqueous carrier medium is tap water.

3. The composition of claim 1, wherein the freezing point depressant is an alkyl polyol.

4. The composition of claim 3, wherein the freezing point depressant is propylene glycol.

5. The composition of claim 1, further comprising, as an additional particulate component, a wheat gluten component.

6. A preventative sealant composition for injection into inflatable tires, the composition comprising
about 43.5% by volume of propylene glycol as a freezing point depressant;
about 43.5% by volume water;
about 6.25% corn gluten meal;
about 6.25% by volume finely ground rubber from used tires; and
about 0.50% wheat gluten by volume; and
about 1.00% zinc phosphate as a rust preventative.

7. A method of sealing a leak in a tire where the tire is inflated by means of a valve and valve core, the method comprising the steps of:
removing the valve core and deflating the tire;
injecting a flowable sealant composition into the tire under pressure, wherein the sealant composition comprises:
from about 5 to 95% by volume, based on the total volume of the composition, of an aqueous carrier medium;
from about 95 to 5% by volume freezing point depressant;
from about 3 to 10% by volume of fine ground rubber particles obtained from used tires;
from about 3 to 10% by volume of a corn meal gluten component; and
thereafter replacing the valve core and reinflating the tire.

8. The method of claim 7, wherein the aqueous carrier medium is tap water.

9. The method of claim 7, wherein the freezing point depressant is an alkyl polyol.

10. The method of claim 7, wherein the freezing point depressant is propylene glycol.

11. The method of claim 7, wherein the sealant composition has, as an additional particulate component, a wheat gluten component.
